(19) United States
(12) Patent Application Publication
(10) Pub. No.: US 2020/0377680 A1
(43) Pub. Date: Dec. 3, 2020

(54) SHONALI BAG

(71) Applicants: Mohammed Rahman, Richmond Hill, NY (US); Mubarak Khan, Richmond Hill, NY (US)

(72) Inventors: Mohammed Rahman, Richmond Hill, NY (US); Mubarak Khan, Richmond Hill, NY (US)

(21) Appl. No.: 16/879,954

(22) Filed: May 21, 2020

Related U.S. Application Data
(60) Provisional application No. 62/854,554, filed on May 30, 2019.

(51) Int. Cl. C08J 5/24; C08K 3/012; C08L 3/02; C08K 3/26; C08L 1/02; C08K 5/10; B65D 65/46

(52) U.S. Cl. CPC C08J 5/24; C08K 3/012; C08L 3/02; C08K 3/26; C08J 3/247; C08K 5/10; B65D 65/466; C08K 2003/265; C08K 2003/267; C08L 1/02

(57) ABSTRACT

Disclosed herein is a composite material composition for producing a biodegradable composite material. The biodegradable composite material is at least one of air resistant and water-resistant. Further, the composite material composition includes fiber present in an amount of from 30% to 50% by weight based on the total weight of the composite material composition. Further, the composite material composition includes starch present in an amount of from 20% to 40% by weight based on the total weight of the composite material composition. Further, the composite material composition includes filler particles present in an amount of from 20% to 40% by weight based on the total weight of the composite material composition and at least one binding agent present in an amount of from 1% to 5% by weight based on the total weight of the composite material composition. Further, the at least one binding agent is biodegradable.

### RELATED APPLICATION(S)

Under provisions of 35 U.S.C. § 119e, the Applicant(s) claim the benefit of U.S. provisional application No. 62/854,554, titled “Jute Bag”, filed on May 30, 2019 which is incorporated herein by reference.

### TECHNICAL FIELD

Generally, the present disclosure relates to a biodegradable composite material.

### BACKGROUND

Polythene is petroleum based synthetic substance which is used as packaging material due to its thermos-mechanical properties and low cost. But it is not biodegradable; therefore, the disposal of plastic waste becomes a serious problem.

According to some estimates, in one minute, more than one million plastic bags are in used all around the world. Further, 3.4 million tons of plastic bags are produced in just one year. This is leading to a worldwide pollution crisis.

Therefore, there is a need for an improved biodegradable composite material for bags and an improved process to produce biodegradable composite material that may overcome one or more of the above-mentioned problems and/or limitations.

### BRIEF SUMMARY

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a composite material composition for producing a biodegradable composite material. The biodegradable composite material may be at least one of air resistant and water-resistant. Further, the composite material composition may include fiber present in an amount of from 30% to 50% by weight based on the total weight of the composite material composition. Further, the composite material composition may include starch present in an amount of from 20% to 40% by weight based on the total weight of the composite material composition. Further, the composite material composition may include filler particles present in an amount of from 20% to 40% by weight based on the total weight of the composite material composition. Further, the composite material composition may include at least one binding agent present in an amount of from 1% to 5% by weight based on the total weight of the composite material composition. Further, the at least one binding agent may be biodegradable.

Further disclosed herein is a process for manufacturing a biodegradable composite material, in accordance with some embodiments. The biodegradable composite material may be at least one of water-resistant and air resistant. Further, the process may include treating at least one fibrous material with at least one alkali solution. Further, the at least one fibrous material may include fiber. Further, the process may include extracting the fiber from the at least one fibrous material based on the treating. Further, the process may include blending the fiber with one or more of at least one binding agent and water forming a composite material preform. Further, the process may include applying at least one of a specific temperature and a specific pressure to the composite material preform. Further, the applying may initiate a chemical reaction in the composite material preform. Further, the chemical reaction may produce the biodegradable composite material from the composite material preform.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a table listing ingredients of a composite material composition for producing a biodegradable composite material, the ingredients being in percent by weight in accordance with some embodiments.

FIG. 2 is a flow chart of a process for manufacturing a biodegradable composite material, in accordance with some embodiments.

FIG. 3 is a front view a bag, in accordance with some embodiments.

FIG. 4 is a rear view of the bag.

FIG. 5 is a front top perspective view of the bag.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of a biodegradable composite material, embodiments of the present disclosure are not limited to use only in this context.

Overview:

According to some embodiments, the present disclosure is directed to a jute bag that is made of cellulose extracts from jute fiber. The disclosed jute bag is biodegradable, yet it is water and air resistant. Further, the texture of the jute bag is almost same as polythene bags.

Furthermore, the material used to make the disclosed jute bag is durable and strong. Jute polymer may take one and half times more load than polythene. Although the polymer does not absorb the water, it decomposes within 3-4 months under soil. Unlike synthetically produced plastic bags, the jute bag is 100% bio-degradable in nature. Therefore, the disclosed jute bag is earth-friendly.

Moreover, the jute plants are natural and renewable. Further, the jute plant is abundant in nature. Therefore, jute is one of the most affordable natural fibers in existence.

The process used to produce the disclosed jute bags does not involve the use of oil or gas, unlike the process used for production of plastic bags, where both oil and gas are used. Both oil and gas are non-renewable energy sources; therefore, they are in limited supply.

According to some embodiments, the present disclosure relates to a jute bag that includes two sheets joined together on the sides via two side panels. Each of the two sheets has largely rectangular shape. The jute bag may include a gusseted bottom. The gusseted bottom may include two opposed gusset panels each joined to a respective sheet of the bag at a bottom fold.

One or more of the sheets, the side panels, the gusseted bottom, and the gusset panel is made from ingredients including jute cellulose, synthetic polymers, and a cross linker.

The process to produce the sheets includes blending the jute cellulose with one or more of a binder, polymers, and water. The binder may be a biodegradable material. Alternatively, the binder may be synthetic polymer. Further, cross linker may be included to aid the chemical reaction. Further, a specific temperature and pressure may be provided to initiate the chemical reaction. The chemical reaction results in a material that is used to produce the one or more of the sheets, the side panels, the gusseted bottom, and the gusset panel.

Further, the chemical composition of Jute fiber includes 65.2% cellulose and 22.2% hemicellulose, 12.5% lignin, 1.5% water-soluble matter, 0.6% fat, and wax. In further embodiments, the jute fiber may be blended with other natural fibers such as cotton, flax, ramie, hemp, sisal, manila hemp, wool, and silk.

According to some embodiments, the present disclosure relates to a jute bag that is made of cellulose extracts from jute fiber. The jute bag may be made of sheets, which are made from ingredients including jute cellulose, synthetic polymers, and a cross linker. The process to produce the sheets may include blending the jute cellulose. Then, binder, polymers, and water may be mixed as well. The binder may be a biodegradable material.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

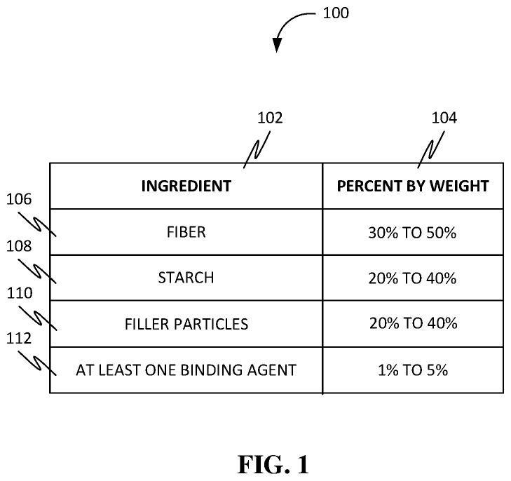

Referring now to figures, FIG. 1 is a table 100 listing ingredients of a composite material composition for producing a biodegradable composite material, the ingredients being in percent by weight in accordance with some embodiments. Further, the biodegradable composite material may be at least one of air resistant and water-resistant.

Further, the table 100 may include two columns 102-104 and four rows 106-112. Further, the table 100 may include 8 cells—(column 102, row 106), (column 104, row 106), (column 102, row 108), (column 104, row 108), (column 102, row 110), (column 104, row 110), (column 102, row 112) and (column 104, row 112). Further, the composite material composition may include one or more of fiber, starch, filler particles, and at least one binding agent. In some embodiments, the composite material composition may also include at least one cross-linking substance.

As shown in the table 100, the cell (column 102, row 106) may be related to fiber. Further, the cell (column 104, row 106) shows that the composite material composition may include fiber in an amount of from 30% to 50% by weight based on the total weight of the composite material composition. Further, the fiber may be biodegradable.

Further, the fiber may include a plurality of natural fibers that may include jute fiber. Further, the jute fiber may be derived from at least one part of a jute plant. Further, the plurality of natural fibers may include first natural fiber and second natural fiber. Further, a first amount of the first natural fiber by weight may be blended with a second amount of the second natural fiber by weight in a blending ratio.

Further, the fiber may include natural fiber and synthetic fiber. Further, a first amount of the natural fiber by weight and a second amount by weight of the synthetic fiber may be blended in a fiber blend ratio.

As shown in the table 100, the cell (column 102, row 108) may be related to starch. Further, the cell (column 104, row 108) shows that the composite material composition may include starch present in an amount of from 20% to 40% by weight based on the total weight of the composite material composition. Further, the starch may be derived from at least one of a corn, a potato, and a sunflower.

Further, the fiber may include synthetic fiber such as polyester fiber. Further, the polyester fiber and the starch may form a bioplastic base composition. Further, the bioplastic base composition may be present in an amount of from 55% to 79% by weight based on the total weight of the composite material composition.

As shown in the table 100, the cell (column 102, row 110) may be related to filler particles. Further, the cell (column 104, row 110) shows that the composite material composition may include filler particles present in an amount of from 20% to 40% by weight based on the total weight of the composite material composition.

Further, the filler particles may include at least one of dolomite particles and calcium carbonate particles. Further, at least one filler particle of the filler particles may include at least one polished surface.

As shown in the table 100, the cell (column 102, row 112) may be related to at least one binding agent. Further, the cell (column 104, row 112) shows that the composite material composition may include at least one binding agent present in an amount of from 1% to 5% by weight based on the total weight of the composite material composition. Further, the at least one binding agent may be biodegradable. Further, the at least one binding agent may include at least one resin ester based on at least one vegetable.

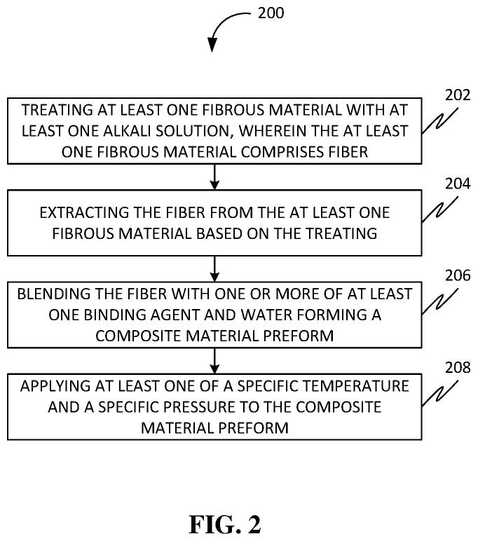

FIG. 2 is a flow chart of a process 200 for manufacturing a biodegradable composite material, in accordance with some embodiments. Further, the biodegradable composite material may be at least one of water-resistant and air resistant.

Further, at 202, the process 200 may include treating at least one fibrous material with at least one alkali solution. Further, the at least one fibrous material may include fiber. Further, the fiber may be biodegradable. Further, the fiber may include synthetic fiber such as polyester fiber. Further, the at least one fibrous material may include at least one part of a jute plant. Further, the fiber may include jute fiber. Further the at least one fibrous material may include at least one part of a rice plant. Further, the fiber may include rice fiber.

Further, at 204, the process 200 may include extracting the fiber from the at least one fibrous material based on the treating.

Further, at 206, the process 200 may include blending the fiber with one or more of at least one binding agent and water forming a composite material preform. Further, the at least one binding agent may include at least one resin ester based on at least one vegetable.

Further, at 208, the process 200 may include applying at least one of a specific temperature and a specific pressure to the composite material preform. Further, the applying may initiate a chemical reaction in the composite material preform. Further, the chemical reaction may produce the biodegradable composite material from the composite material preform.

According to some embodiments, the fiber may include coarse fiber. Further, the process 200 may further include treating the coarse fiber with at least one enzyme solution. Further, the at least one enzyme solution may include at least one of a cellulase preparation and a xylanase preparation.

In further embodiments, the process 200 may include adding at least one cross-linking substance to the composite material preform. Further, the adding may aid the chemical reaction in the composite material preform.

The process 200 does not involve the use of oil or gas, unlike the process used for production of plastic bags, where both oil and gas are used. Both oil and gas are non-renewable energy sources; therefore, they are in limited supply.

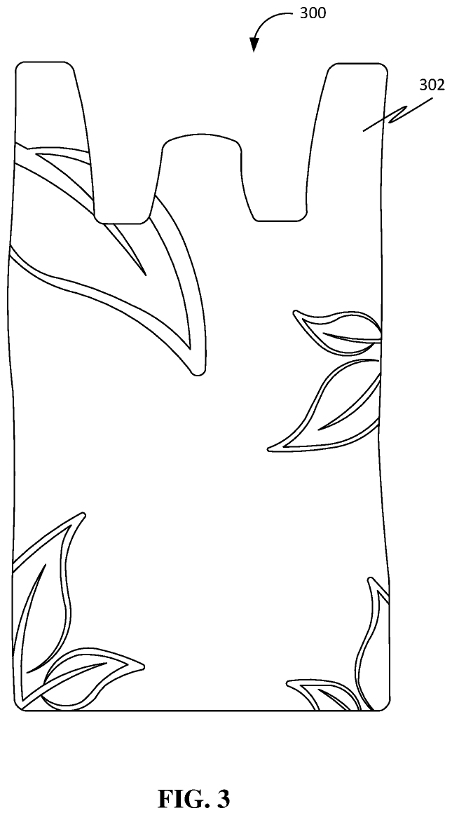

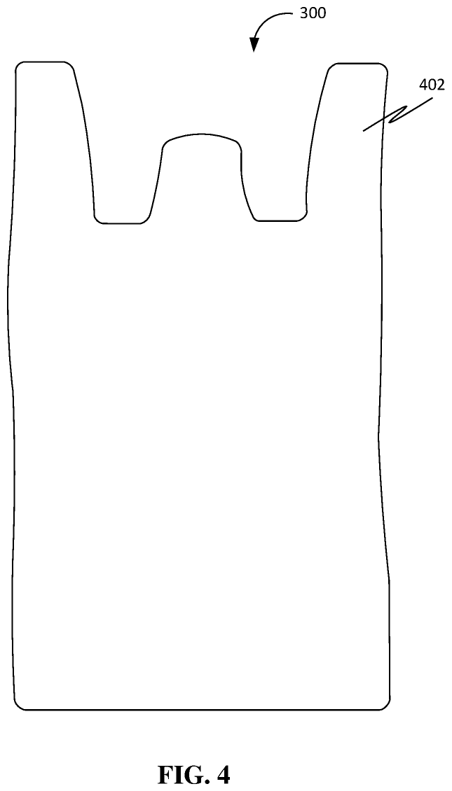

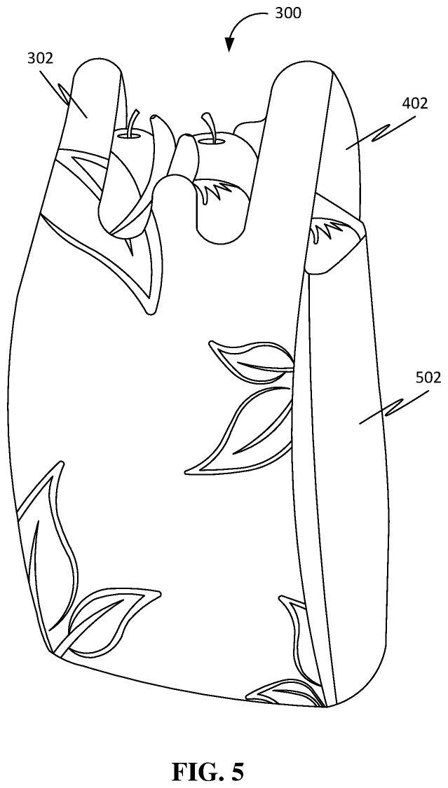

FIG. 3 is a front view a bag 300, in accordance with an embodiment. FIG. 4 is a rear view of the bag 300. FIG. 5 is a front top perspective view of the bag 300. The bag 300 may be made from the biodegradable composite material. The bag 300 may be called “sonali” bag or “shonali” bag.

Further, the bag 300 may be made by joining two sheets of the biodegradable composite material on the sides via two side panels. Each of the two sheets may have largely rectangular shape. The two sheets may include a sheet 302 shown in FIG. 3 and a sheet 402 shown in FIG. 4. Further, the two side panels may include a first side panel 502. A second side panel of the two side panels is not shown in the figures.

Further, the bag 300 may include a gusseted bottom (not shown). The gusseted bottom may include two opposed gusset panels each joined to a respective sheet of the bag 300 at a bottom fold. The bag 300 may be durable and strong.

The bag 300 may be biodegradable, yet it may be water and air resistant. Further, the texture of the bag 300 may be almost same as polythene bags. Furthermore, the material used to make the disclosed bag 300 may be durable and strong. Further, the bag 300 may take one and half times more load than a polythene bag. Although the material used to make the disclosed bag 300 does not absorb the water, it decomposes within 3-4 months under soil. Unlike synthetically produced plastic bags, the bag 300 may be 100% bio-degradable in nature. The bag 300 may be earth-friendly.

Although the present disclosure has been explained in relation to its preferred embodiment, it is to be understood that many other possible modifications and variations can be made without departing from the spirit and scope of the disclosure.

The following is claimed:

1. A composite material composition for producing a biodegradable composite material, wherein the biodegradable composite material is at least one of air resistant and water-resistant, wherein the composite material composition comprises:
fiber present in an amount of from 30% to 50% by weight based on the total weight of the composite material composition;
starch present in an amount of from 20% to 40% by weight based on the total weight of the composite material composition;
filler particles present in an amount of from 20% to 40% by weight based on the total weight of the composite material composition; and
at least one binding agent present in an amount of from 1% to 5% by weight based on the total weight of the composite material composition, wherein the at least one binding agent is biodegradable.

2. The composite material composition of claim 1, wherein the fiber is biodegradable.

3. The composite material composition of claim 1, wherein the fiber comprises synthetic fiber, wherein the synthetic fiber comprises polyester fiber.

4. The composite material composition of claim 3, wherein the polyester fiber and the starch form a bioplastic base composition, wherein the bioplastic base composition is present in an amount of from 55% to 79% by weight based on the total weight of the composite material composition.

5. The composite material composition of claim 1, wherein the fiber comprises a plurality of natural fibers, wherein the plurality of natural fibers comprises jute fiber, wherein the jute fiber is derived from at least one part of a jute plant.

6. The composite material composition of claim 5, wherein the plurality of natural fibers comprises first natural fiber and second natural fiber, wherein a first amount of the first natural fiber by weight is blended with a second amount of the second natural fiber by weight in a blending ratio.

7. The composite material composition of claim 1, wherein the fiber comprises natural fiber and synthetic fiber, wherein a first amount of the natural fiber by weight and a second amount by weight of the synthetic fiber are blended in a fiber blend ratio.

8. The composite material composition of claim 1, wherein the filler particles comprises at least one of dolomite particles and calcium carbonate particles.

9. The composite material composition of claim 1, wherein at least one filler particle of the filler particles comprises at least one polished surface.

10. The composite material composition of claim 1, wherein the starch is derived from at least one of a corn, a potato, and a sunflower.

11. The composite material composition of claim 1, wherein the at least one binding agent comprises at least one resin ester based on at least one vegetable.

12. The composite material composition of claim 1 further comprising at least one cross-linking substance.

13. A process for manufacturing a biodegradable composite material, wherein the biodegradable composite material is at least one of water-resistant and air resistant, wherein the process comprises:
treating at least one fibrous material with at least one alkali solution, wherein the at least one fibrous material comprises fiber;
extracting the fiber from the at least one fibrous material based on the treating;
blending the fiber with one or more of at least one binding agent and water forming a composite material preform; and
applying at least one of a specific temperature and a specific pressure to the composite material preform, wherein the applying initiates a chemical reaction in the composite material preform, wherein the chemical reaction produces the biodegradable composite material from the composite material preform.

14. The process of claim 13, wherein the fiber is biodegradable.

15. The process of claim 13, wherein the fiber comprises coarse fiber, wherein the process further comprises treating the coarse fiber with at least one enzyme solution, wherein the at least one enzyme solution comprises at least one of a cellulase preparation and a xylanase preparation.

16. The process of claim 13 further comprising adding at least one cross-linking substance to the composite material preform, wherein the adding aids the chemical reaction in the composite material preform.

17. The process of claim 13, wherein the at least one fibrous material comprises at least one part of a jute plant, wherein the fiber comprises jute fiber.

18. The process of claim 13, wherein the at least one fibrous material comprises at least one part of a rice plant, wherein the fiber comprises rice fiber.

19. The process of claim 13, wherein the at least one binding agent comprises at least one resin ester based on at least one vegetable.

20. The process of claim 13, wherein the fiber comprises synthetic fiber, wherein the synthetic fiber comprises polyester fiber.
